(19) United States
(12) Patent Application Publication
(10) Pub. No.: US 2010/0176638 A1
(43) Pub. Date: Jul. 15, 2010

(54) VEHICLE SEAT WITH FOLDABLE BACKREST PART

(75) Inventors: Harald CZERWENSKI, Russelsheim (DE); Hans-Peter GIMBEL, Trebur (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/683,654

(22) Filed: Jan. 7, 2010

(30) Foreign Application Priority Data
Jan. 7, 2009 (DE) 102009003941.4

(51) Int. Cl. B60N 2/20; B60N 2/02

(52) U.S. Cl. 297/340; 297/378.1; 297/311

(57) ABSTRACT

A vehicle seat is provided with a seat part with a backrest part that can be folded over in the direction of the seat part. The seat part with respect to the vehicle longitudinal direction comprises a front seat part and a back seat part of which the front seat part for forming a base for the backrest part can be transferred into a forward folded position and the back seat part is stationarily arranged on a vehicle structure.

### CROSS-REFERENCE TO RELATED APPLICATION

This application claims priority to German Patent Application No. 102009003941.4, filed Jan. 7, 2009, which is incorporated herein by reference in its entirety.

### TECHNICAL FIELD

The present invention relates to a vehicle seat, more preferably for motor vehicles, with a seat part and with a backrest part that can be folded over in direction of the seat part for enlarging the load volume of the vehicle.

### BACKGROUND

Vehicle seats that can be folded over, more preferably the back seats of a vehicle with a backrest part that can be folded over to the front are known in the prior art. Typically with a vehicle back seat a seat area is initially folded forward in order to then swivel the backrest into a region in which the seat area was located in its original position.

Such configurations are often accompanied by the disadvantage that a seat cushion folded over to the front comes to lie between the back of a front seat and the upper end section of the backrest part folded over to the front. Oftentimes the seat cushion even protrudes over the load area formed by the backrest part which can have a disadvantageous effect on the load volume.

From DE 10 2004 059 213 A1 a vehicle seat is additionally known wherein a seat part is divided transversely to a driving direction by a separating joint into a front and a back seat part. Upon displacement of the vehicle seat from its seat position into a load position the front seat part in a first folding and subsequently the backrest part through a second folding are each folded over to the front in driving direction. Although when doing so a substantially flat load floor can be created, it proves to be disadvantageous with such a seat however that the back seat part is firmly connected with the backrest part and arranged on the latter.

This assembly, which comprises the backrest and the back seat part, has an L-shaped profile in cross section. On swiveling the backrest part to the front it is therefore required that adequate free space is made available below the back seat part so that joint swiveling of backrest part and back seat part is possible. The size of this free space has to be adapted to the length of the back seat part folded away to the bottom.

Because of the tight space conditions in a vehicle, only relatively short configurations of the back seat part are possible for such a seat configuration. Typically the front seat part to be folded over to the front therefore has to be designed larger, or longer than the back seat part. However, this can bring with it the disadvantage that a front seat part folded over protrudes from the load area upwards.

Embodiments of the present invention in contrast are based on at least the object of making available an improved vehicle seat with a foldable backrest part which for the transfer from a seat position into a load position requires a minimum of space. Furthermore, the seat part capable of being swiveled should be designed with preferably small dimensions and have a preferably low mass in order to make possible particularly light operation of the swivel movement and thus particularly easy handling. In addition, other objects, desirable features and characteristics will become apparent from the subsequent summary and detailed description, and the appended claims, taken in conjunction with the accompanying drawings and this background.

### SUMMARY

The vehicle seat according to an embodiment of the invention, which more preferably is designed as a back seat of a motor vehicle, comprises a seat part and a backrest part, wherein the backrest part in the direction of the seat part, i.e. seen in driving direction of the vehicle, can be folded over to the front. Furthermore, the seat part, relative to the vehicle longitudinal direction, or the driving direction, comprises a front seat part and a back seat part, of which the front seat part can be transferred into a forward-folded position for forming a base for the backrest part.

Herein it is provided that the back seat part can be arranged or is arranged stationarily on the vehicle structure. Herein it is additionally provided that the back seat part remains arranged on the vehicle structure even independent of a swivel movement of the front seat part and/or the backrest part.

In that merely the front seat part is designed capable of being swiveled to the front, but the back seat part is arranged stationarily on or with respect to the motor vehicle structure, the mass of the parts which are moveable upon a transfer from the seat position into the load position of the vehicle seat can be advantageously reduced.

The vehicle seat, more preferably its seat part and its backrest part are designed and matched to each other in such a manner that for forming a preferentially flat load floor merely the front seat part and the backrest part have to be folded over to the front while the back seat part always remains in the same position or arrangement independent of seat position or load position of the vehicle seat.

The embodiments of the invention herein make particular use of the outer contour of seat part and backrest part or corresponding rest or seat cushions. Thus it is provided according to the invention that the back seat part is arranged in the region of a depression, such as a seat trough, in which the back part on assuming the load position comes to lie with its loin region or a lordotic support.

The base which is formed through the folding forward of the front seat part in contrast is preferentially if not exclusively provided for accommodating an upper section of the backrest part and suitably designed for this purpose. Depending on mutual shaping corresponding to each other of seat part and backrest part the size of the front seat part to be folded over to the front can be adapted to the dimensions of the upper end section of the backrest part.

According to a first advantageous embodiment of the invention it is provided that the back seat part is mechanically decoupled from the front seat part and/or from the backrest part. This means folding over of the front seat part like folding over of the backrest part has no noteworthy effect on the back seat part of the vehicle seat.

An advantage is that the back seat part is directly arranged on the underbody of the vehicle. Here it can be more preferably provided to arrange the back seat part directly on a so-called submarining ramp which forms a seat trough for the vehicle occupant facing to the back, that is the backrest part and in the event of a vehicle collision serves to counteract slipping-through of the pelvic region of the vehicle occupant through the lap belt.

According to a further advantageous embodiment of the invention it is provided that the front seat part is mounted capable of being swiveled on an axis running in vehicle transverse direction. Here, more preferably a rotary mounting of the front seat part is provided. For example the front seat part can be mounted immediately and directly to the axis in a manner capable of being swiveled by means of a connecting element, for example a strut or a connecting means of that type. In this manner a particularly robust, simple and intuitively operable swiveling mechanism that additionally saves costs in the manufacture can be made available for the front seat part.

By swiveling the front seat part from its seat position into the load position a base for at least a part region of the backrest part is formed. Since the seat part as a whole runs inclined downwards in the direction of the backrest part, the front seat part in its seat position forms the highest elevation of the entire seat part. By folding over the front seat part into its load position a base, or a depression at least for the partial accommodation of the backrest part can be made available in the region of the highest elevation, so that ultimately a swiveling angle that is adequate for forming a flat load floor can be made available for the backrest part.

According to a further particularly advantageous embodiment of the invention it is provided that the front seat part is mechanically coupled with the backrest part. Thus a swivel movement of the front seat part between seat position and load position can be coupled with a corresponding swivel movement of the backrest part. Such mechanical coupling makes possible for example that transferring the backrest part from its seat position into the load position initiated by a user automatically brings about a corresponding adjusting movement of the front seat part.

With this embodiment coupling between backrest part and front seat part can further be designed in such a manner that a swivel movement of the backrest part directed to the front is accompanied by a swiveling of the front seat part into the forward folded position.

According to a further independent embodiment of the invention it is provided that the front seat part from a seat position, in which it forms a seat plane with the back seat part, under the effect of a spring force is automatically or largely automatically transferable into a swivel position for forming the base for the upper end section of the backrest part.

Here it is more preferably provided that the front seat part has a comparatively low mass and/or preferably small geometrical dimensions so that swiveling of the front seat part from the seat position into the swiveling position or load position can take place subject to preferably low effect of force which has to be exerted by the spring element or the spring storage element.

For providing adequate spring force, tension springs, compression springs, rotary springs or gas pressure springs can be used as required.

While swiveling of the front seat part from the seat position into the load position takes place under spring effect, it is provided with a further embodiment that an opposite swivel movement of the front seat part, i.e. from the load position into the seat position results in a tensioning of the spring element. The swivel movement of the front seat part from the load position back into the seat position can also be coupled with the corresponding swivel movement of the backrest part, so that the user for transferring the entire vehicle seat between seat position and load position merely requires the corresponding swivel movement of the backrest part.

According to a further independent aspect of the invention it is provided that the front seat part is fixed in the seat position by means of a locking device. This is particularly advantageous with such embodiments wherein the front seat part is subjected to spring preload. With the releasing of the locking device it can for example be provided that the front seat part is automatically and if applicable exclusively transferred from the seat position into the load position under the effect of the spring force made available.

Here it can be furthermore provided that the locking device of the front seat part is operationally connected with an unlocking device of the seat backrest part. The locking or unlocking device provided on the backrest part serves for locking the backrest in its substantially upright seat position. Through such coupling it is conceivable that by unlocking the backrest part located in seat position the locking of the front seat part is cancelled and said seat part as a result of a spring force made available by a spring element or a spring force largely assumes the load position automatically.

According to a further embodiment it can be provided that the unlocking of the backrest part and the locking of the seat part are coupled to each other by means of a flexible pulling/pressure means, more preferably a flexible actuation cable. To that extent, actuation of the backrest unlocking device can be used for releasing the locking device of the seat part through direct and purely mechanical transmission.

It is furthermore conceivable that in addition to said actuation cable additional actuation cables or electromechanical force transmission means are provided, which make available a purely mechanical and/or electrically assisted force transmission, or mechanical coupling of backrest part and front seat part.

The use of actuation cables, such as Bowden cables allows largely free and universal routing of mechanical force transmission means without substantial structural changes having to be carried out on the individual components of the vehicle seat for this purpose.

According to a further embodiment of the invention it is provided that the front seat part capable of being swiveled is designed as front part of a seat mirror of a seat cushion. With this configuration it is provided that not the entire seat cushion in its full width is designed for folding over to the front but only in a middle region seen in vehicle transverse direction, while a lateral frame of the seat cushion remains stationarily arranged on the vehicle structure, such as the underbody of the vehicle, also in the front region of the seat cushion.

In this manner, the weight and the dimensions of the front seat part to be swiveled can be further minimized in an advantageous manner.

Here it is more preferably provided that the width of the front seat part that can be folded over to the front approximately corresponds to the width of a head rest arranged on the backrest part or integrated therein, so that the base formed through swiveling of the front seat part or the front seat mirror is able to accommodate the region of the backrest part formed by the head rest protruding to the front.

In addition, it is provided according to an embodiment of the invention that the back wall of the backrest part in the position folded forward, i.e. on assuming the load position, forms a largely continuous and flat load area with a load floor of the vehicle. The entire load area in this case can have a slight inclination rising to the front in vehicle longitudinal direction. Typical angles of inclination can be within the range from 1 to 5 preferentially between 2 and 3 degrees

According to a further embodiment of the invention it is additionally provided that the size ratio of front seat part to back seat part is approximately ⅓ to ⅔, preferentially even ¼ to ¾. At any rate, the front seat part folded over to the front has lesser outer dimensions than the back seat part. These size ratios and related mass ratios of front and back seat part are more preferably advantageous for automatic swiveling of the front seat and if applicable swiveling of the front seat coupled to the swivel movement of the backrest part or largely spring force assisted.

### BRIEF DESCRIPTION OF THE DRAWINGS

The present invention will hereinafter be described in conjunction with the following drawing figures, wherein like numerals denote like elements, and:

FIG. 1 a schematic cross sectional view of the vehicle seat in seat position;

FIG. 2 a view corresponding to FIG. 1 with the seat during a transfer from seat position to load position; and

FIG. 3 a view corresponding to FIG. 1 and FIG. 2 with the motor vehicle seat located in load position.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

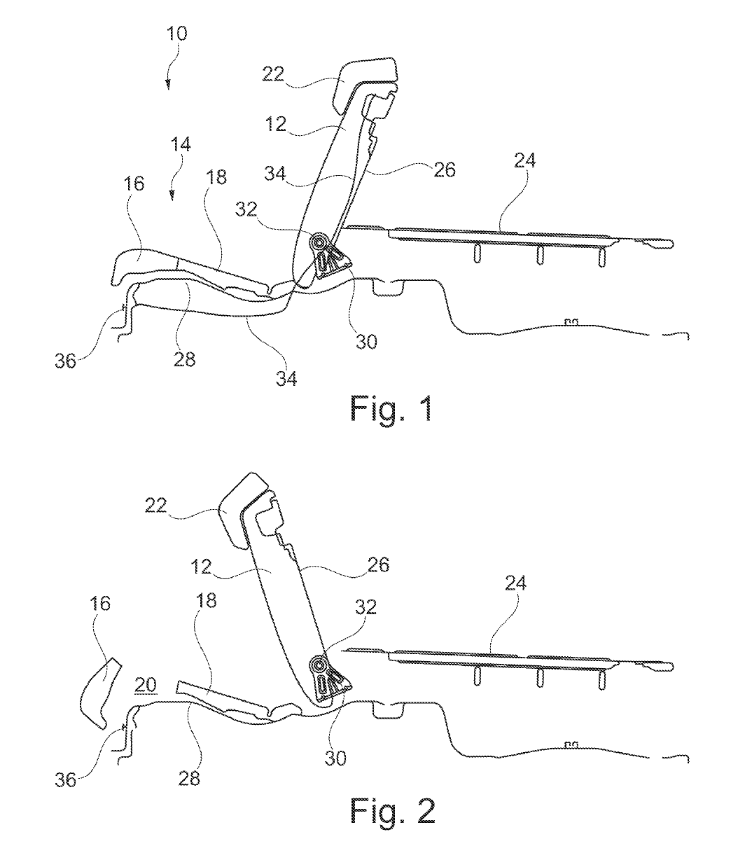

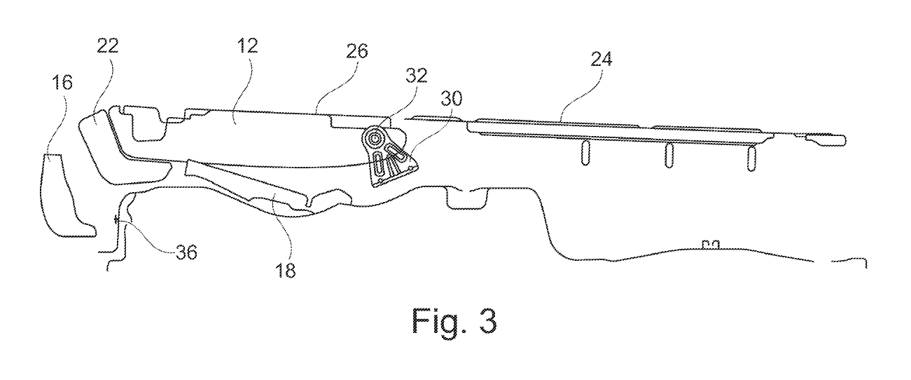

The motor vehicle seat 10 shown in FIG. 1 to FIG. 3 comprises a backrest part 12 and a seat part 14, wherein the seat part 14 is subdivided into a front seat part 16 and a back seat part 18. While the back seat part 18 is arranged stationarily on the vehicle structure, for example an underbody 28 of the motor vehicle, the front seat part 16 is designed capable of being swiveled about a swivel axis 36 between the seat position shown in FIG. 1 and the load position shown in FIG. 3.

Through the swivel movement directed to the front the front seat part 16 exposes a base 20 in which for example a section 22 of the backrest part 12 protruding to the front comes to lie on reaching its load position, as shown in FIG. 3. The section 22 protruding to the front can for example be designed as a headrest 22 implemented in the seat backrest 12 or arranged thereon.

The backrest part 12 is mounted in a holder 30 capable of being swiveled about a swivel axis 32. A corresponding swivel movement of the backrest part 12 is evident by comparing FIG. 1 to FIG. 3.

The back seat part 18 is more preferably arranged in the region of a trough formed by the underbody 28 or by the vehicle structure and runs towards the backrest 12, i.e. to the back, inclined downward. Here it is more preferably provided to arrange the back seat part 18 directly on a so-called submarining ramp 28.

Although not explicitly shown in the drawings, the front seat part 16 capable of being swiveled has a lesser width than the back seat part 18 and/or the seat backrest 12 seen in vehicle transverse direction. The width of the front seat part 16 capable of being swiveled is adapted to the width of the seat component 22 to be accommodated in the base 20, approximately to the width of a headrest 22. Insofar it can be achieved that the base 20 provided for accommodating the headrest 22 only needs to be configured only slightly larger than the region of the headrest 22 protruding to the front.

In that not the entire seat cushion, but merely a seat part 16 designed as seat mirror has to be folded over to the front, a particularly simple and easy to operate fold or swivel mechanism for the front seat part 16 can be made available through a concomitant weight minimization.

Thus it can be provided that the seat part 16 capable of being folded forward is embodied as seat mirror, i.e. in vehicle transverse direction is enclosed on both sides by lateral webs of the front seat cushion so that a separating joint in the front region of the seat cushion follows a U-like course. The separating joint can more preferably be formed in the region of existing tacking of the seat upholstery. The basic design of the vehicle seat, more preferably its seat cushion is thus only insignificantly affected by the invention.

In FIG. 1, an actuation cable 34 is additionally indicated which connects a seat backrest unlocking device arranged on the upper end section of the backrest part 12 with a locking device arranged in the region of the swivel axis 36, or in the region of the front seat part 16. By means of this actuation cable 34 locking of the front seat part 16 can already be cancelled even with the unlocking of the backrest part 12, which for example subject to spring preload, subsequently can automatically assume the load position shown in FIG. 3, without additional operations of the operator being required for this.

In addition it is also conceivable to implement a corresponding unlocking device, for example with a luggage compartment load opening or with the addition of an actuation drive by means of a radio remote control.

As is further shown in FIG. 3, the rear wall 26 of the rest part 12 with the load floor 24 located behind forms a continuous load surface of flat configuration which slightly rises forward with respect to the horizontal, i.e. towards the seat.

The outer dimension of the front seat part 16 extending parallel to the vehicle longitudinal direction, i.e. its length, is clearly less than the length of the back seat part 18. The size ratio or length ratio from front seat part 16 capable of being folded over to the back seat part 18 arranged stationarily is approximately ⅓ to ⅔ or even ¼ to ¾.

Altogether, the embodiments of invention make possible a back seat concept which can be equally used for different passenger cars for example of the type station wagon or sedan.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A seat of a motor vehicle, comprising:
a seat part; and
a backrest part that can be folded over in a direction of the seat part,
wherein the seat part relative to a vehicle longitudinal direction comprises:
a front seat part, and
a back seat part of which the front seat part form a base for the backrest part that can be transferred into a forward folded position,
wherein the back seat part can be stationarily arranged on a vehicle structure.

2. The seat of the motor vehicle according to claim 1, wherein the back seat part is mechanically decoupled from the front seat part.

3. The seat of the motor vehicle according to claim 1, wherein the back seat part is mechanically decoupled from the backrest part.

4. The seat of the motor vehicle according to claim 1, wherein the back seat part is directly arranged on an underbody of the motor vehicle.

5. The seat of the motor vehicle according to claim 1, wherein the front seat part is mounted and adapted to swivel in an axis running in a transverse direction of the motor vehicle.

6. The seat of the motor vehicle according to claim 1, wherein the front seat part is mechanically coupled with the backrest part.

7. The seat of the motor vehicle according to claim 6, wherein the backrest part and the front seat part are mechanically coupled in such a manner that a swivel movement of the backrest part directed to a front brings about a transfer of the front seat part in the forward folded position.

8. The seat of the motor vehicle according to claim 1, wherein the front seat part can be automatically transferred from a seat position that forms a seat plane with the back seat part into a swivel position for forming a base for an upper end section of the backrest part under an effect of a spring force.

9. The seat of the motor vehicle according to claim 8, wherein the front seat part is fixed in the seat position with a locking device.

10. The seat of the motor vehicle according to claim 9, wherein the locking device of the front seat part is operationally connected with an unlocking device of the backrest part.

11. The seat of the motor vehicle according to 9, wherein the unlocking device of the backrest part and the locking device of the seat part are coupled with a flexible actuation cable.

12. The seat of the motor vehicle according to claim 1, wherein the front seat part is adapted to swiveled as a front part of a seat mirror of a seat cushion.

13. The seat of the motor vehicle according to claim 1, wherein the back wall of the backrest part in the forward folded position forms a substantially continuous and flat load surface with a load floor of the motor vehicle.

14. The seat of the motor vehicle according to claim 1, wherein the size ratio of the front seat part to the back seat part amounts to approximately ⅓ to ⅔.

15. The seat of the motor vehicle according to claim 1, wherein the size ratio of the front seat part to the back seat part amounts to approximately ¼ to ¾.
